(19) United States
(12) Patent Application Publication
(10) Pub. No.: US 2006/0033758 A1
(43) Pub. Date: Feb. 16, 2006

(54) A method, process and computer program to automatically create a customized three-dimensional nail object by morphing

(76) Inventors: Scott L. Nielson, Layton, UT (US); Craig P. Gifford, West Jordan, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/710,962

(22) Filed: Aug. 15, 2004

(51) Int. Cl. G09G 5/00

(52) U.S. Cl. 345/646

(57) ABSTRACT

The invention is a method, process and computer program to automatically create a customized three-dimensional artificial nail object by morphing based upon an actual/existing digitized nail surface. This particular invention generates the overall desired three-dimensional nail surface by taking the digitized nail surface and morphing it into a preexisting and preferred artificial nail surface by using key reference points contained in the digitized nail surface. The application of the invention results in a wide scope of possible implementations including a use for creating artificial fingernails and artificial toenails.

### CROSS REFERENCE TO RELATED APPLICATIONS

This application references U.S. patent application Ser. No. 10/708,065, filed Feb. 6, 2004.

### BACKGROUND OF INVENTION

While working with fingernails and fingernail objects for several years, there was no easy way to automatically create a three-dimensional model of an artificial fingernail object. In fact, most software in the market allows a user to manually manipulate and create just about any three-dimensional object conceivable, but the process of doing this manually is very time consuming and allows for too much human error when creating artificial fingernails with a consistent and reliable appearance. Because of this the inventors set out to find a method to create artificial fingernail objects automatically and this invention was the result.

One simple way to create the desired artificial nail object is to start with the desired top surface. This top surface conforms to acceptable and expected curves and thickness for an artificial fingernail. By taking the point array of a digitized nail surface, the invention can morph that array into the preferred top surface and create a new top surface that will be combined with the digitized nail surface (forming the bottom surface of the new object) and the result is a customized and preferred three-dimensional artificial nail object that has many applications.

This new desired three-dimensional object has many applications, not the least of which is the ability to physically create the nail object for the individual and supply them with an artificial nail for use as a cosmetic or even prosthesis. The invention can now safe time and virtually guarantee consistent looking fingernail objects, all accomplished with relative ease.

### SUMMARY OF INVENTION

The invention is a method, process and computer program to automatically create a customized three-dimensional artificial nail object by morphing based upon an actual/existing digitized nail surface. This particular invention generates the overall desired three-dimensional nail surface by taking the digitized nail surface and morphing it into a preexisting and preferred artificial nail surface by using key reference points contained in the digitized nail surface. The application of the invention results in a wide scope of possible implementations including a use for creating artificial fingernails and artificial toenails.

### BRIEF DESCRIPTION OF DRAWINGS

FIG. 1 is a diagram demonstrating the Axis, periphery and digitizing of the nail surface object.

FIG. 2 is a diagram illustrating the morphing process.

FIG. 3 is a diagram showing the new customized nail object fitting over the digitized surface.

### DETAILED DESCRIPTION

By starting with an existing digitized three-dimensional surface point array of an actual fingernail or toenail, the invention permits the automatic creation of a new customized three-dimensional object that will fit over the actual fingernail or toenail. This is accomplished by measuring key points of data contained in the digitized array and then selecting a preexisting and preferred top surface three-dimensional point array and morphing the digitized surface into the preferred surface. The morphing process may undergo several iterations to successfully create the top surface that is desired. Once the top surface has been created, then the top surface is combined with the existing digitized nail surface, which forms the bottom of the final nail object. By combining the two three-dimensional object arrays, a new three-dimensional artificial nail object is created that is customized and desired.

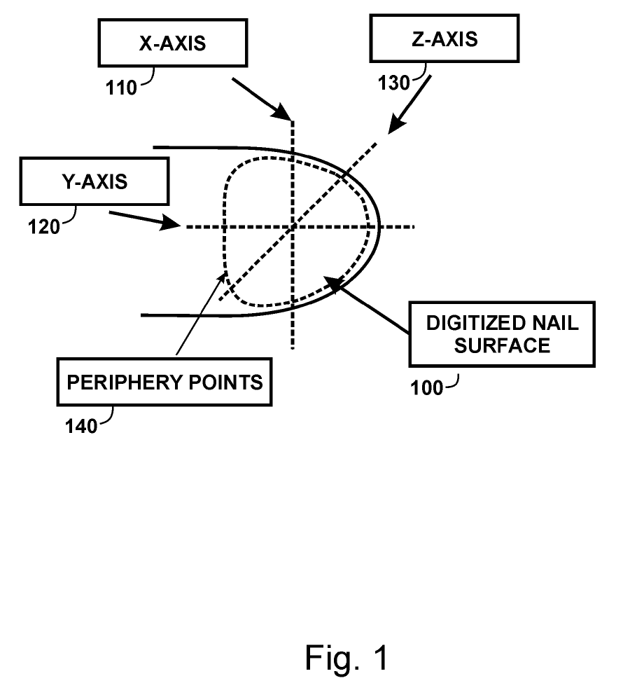

In FIG. 1 the first step of the process is demonstrated, where a digitized nail surface 100 is shown and the orientation of the X, Y and Z Axis is established. Here the X-axis 110 is found along the width of the digitized nail surface 100; the Y-axis 120 is the length of the digitized nail surface 100 and can be determined initially by measuring from the cuticle to the tip of the digitized nail surface 100; and the Z-axis 130 represents the height or depth of the digitized nail surface 100. Additionally, the periphery points 140 are also determined in the first step to insure that the digitized nail surface 100 dimensions will fit into the morphed preferred three-dimensional array. All of these reference points are used to initialize and determine the morphing process which will create the new three-dimensional data representing the top surface of the final three-dimensional customized nail object 300.

Measuring the digitized surface area includes creating a relationship of the X-axis 110, Y-axis 120 and Z-axis 130 to millimeters or inches, further arcs and curves of the digitized nail surface 100 are determined by measuring and creating relationships between the three-dimensional points of data along the X-axis 110, Y-axis 120 and Z-axis 130. These curves and arcs are utilized and manipulated during the morphing process in an effort to make the digitized nail surface 100 appear more like the preferred surface 200.

Using the periphery points 140 is vital to insure that the morphing process 210 will create an eventual three-dimensional object that will fit over the digitized nail surface 100. The periphery points 140 are maintained during the morphing process 210 to insure that the preferred surface 200 reshapes to combine with the digitized nail surface 100 into a single customized nail object 300 which will fit over the digitized nail surface 100.

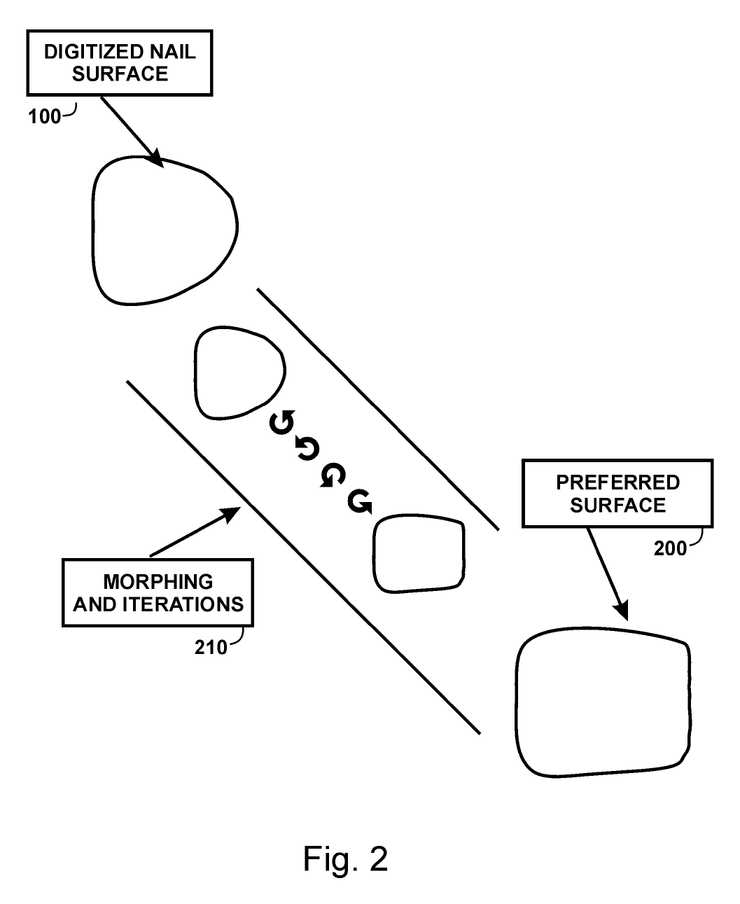

FIG. 2 shows the morphing process 210. This step starts with the digitized nail surface 100 and the preferred surface 200. Morphing begins by mathematically changing the digitized nail surface 100 to appear more like the preferred surface 200 while maintaining the key reference points. Additionally, the preferred surface 200 is made to appear more like the digitized nail surface 100 during each morphing iteration 210. The morphing is accomplished by mathematically making the X-axis 110, Y-axis 120 and Z-axis 130 more similar to the other array of points. The periphery points 140 remain constant when morphing 210 from the digitized nail surface 100 to the preferred surface 200 so as to insure that the new three-dimensional nail surface object created by morphing 210 will combine successfully with the digitized nail surface 100 in it original state to create the customized nail object 300.

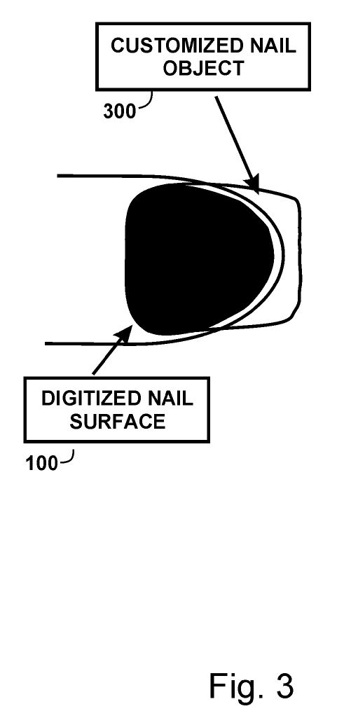

FIG. 3 shows the morphed top surface combined with the digitized nail surface 100 as one customized nail object 300, fitting over the top of the original digitized nail surface 100.

By completing the steps above, virtually any software program or user would be capable of creating a desired and customized three-dimensional artificial nail object. The entire objective of the preferred embodiments of the invention has been to create a simplified method, process and computer program to automatically create a customized three-dimensional nail object by morphing an existing nail surface into a preferred nail top surface. The application of this invention is extensive and plentiful, as with this invention it will become trivial to generate desired three-dimensional artificial nail objects by automation quickly and easily. Because of the advantages inherent in this invention it is anticipated that many variants of this invention are possible, which should be included within the preferred embodiments and descriptions of this invention.

1. A method to automatically create a three-dimensional nail object, comprising:
starting with a three-dimensional array of data representing a digitized nail surface, and;
measuring key reference points along the nail surface along the X-axis, Y-axis, Z-axis and the periphery of the digitized nail surface, and;
morphing the digitized nail surface into a preexisting preferred artificial nail surface to create a customized top nail surface, and;
combining the morphing top nail surface with the digitized nail surface to create a final customized and preferred three-dimensional artificial nail object that conforms to an expected result so that the nail object will fit over the digitized nail surface and create a desired artificial nail appearance.

2. The method of claim 1, wherein starting with a three-dimensional array of data representing a digitized nail surface includes any data that can be used to represent a three-dimensional object.

3. The method of claim 1, wherein the three-dimensional array of data may be represented as points of data representing an X-axis, Y-axis and Z-axis. The three-dimensional array of data may also include the points defining the periphery of the digitized nail surface.

4. The method of claim 1, wherein measuring key reference points includes determining the measurement value in millimeters or inches of the nail surface along its X-axis, Y-axis and Z-axis; where X-axis represents width, Y-axis represents the length and Z-axis represents depth.

5. The method of claim 1, wherein measuring key reference points includes determining the arc of the digitized nail surface along the X-axis and/or determining the arc of the nail surface along the Y-axis.

6. The method of claim 1, wherein measuring key reference points includes evaluating three-dimensional points along the periphery of the nail surface.

7. The method of claim 1, wherein morphing the digitized surface includes an iteration of mathematically manipulating the three-dimensional point array of the digitized nail surface to become more similar along the X-axis, Y-axis and Z-axis to the three-dimensional point array of the preexisting and preferred three-dimensional nail surface point array.

8. The method of claim 7, wherein the method of mathematically becoming more similar would be considered an iteration and the morphing process may take several iterations to arrive at a desired top surface object.

9. The method of claim 1, wherein the customized and preferred nail object is achieved by combining the three-dimensional point array from the morphing method as the top surface of the desired nail object and the digitized nail surface forms the bottom surface of the desired nail object. The two surfaces are then combined to create the customized and preferred three-dimensional nail object.

10. The method of claim 1, wherein the desired nail object in its final state is a customized three-dimensional object representing an artificial nail that is desired, which fits over the digitized nail surface.

11. A process to automatically create a three-dimensional nail object, comprising:
starting with a three-dimensional array of data representing a digitized nail surface, and;
measuring key reference points along the nail surface along the X-axis, Y-axis, Z-axis and the periphery of the digitized nail surface, and;
morphing the digitized nail surface into a preexisting preferred artificial nail surface to create a customized top nail surface, and;
combining the morphing top nail surface with the digitized nail surface to create a final customized and preferred three-dimensional artificial nail object that conforms to an expected result so that the nail object will fit over the digitized nail surface and create a desired artificial nail appearance.

12. The process of claim 11, wherein starting with a three-dimensional array of data representing a digitized nail surface includes any data that can be used to represent a three-dimensional object.

13. The process of claim 11, wherein the three-dimensional array of data may be represented as points of data representing an X-axis, Y-axis and Z-axis. The three-dimensional array of data may also include the points defining the periphery of the digitized nail surface.

14. The process of claim 11, wherein measuring key reference points includes determining the measurement value in millimeters or inches of the nail surface along its X-axis, Y-axis and Z-axis; where X-axis represents width, Y-axis represents the length and Z-axis represents depth.

15. The process of claim 11, wherein measuring key reference points includes determining the arc of the digitized nail surface along the X-axis and/or determining the arc of the nail surface along the Y-axis.

16. The process of claim 11, wherein measuring key reference points includes evaluating three-dimensional points along the periphery of the nail surface.

17. The process of claim 11, wherein morphing the digitized surface includes an iteration of mathematically manipulating the three-dimensional point array of the digitized nail surface to become more similar along the X-axis, Y-axis and Z-axis to the three-dimensional point array of the preexisting and preferred three-dimensional nail surface point array.

18. The process of claim 17, wherein the process of mathematically becoming more similar would be considered an iteration and the morphing process may take several iterations to arrive at a desired top surface object.

19. The process of claim 11, wherein the customized and preferred nail object is achieved by combining the three-dimensional point array from the morphing process as the top surface of the desired nail object and the digitized nail surface forms the bottom surface of the desired nail object. The two surfaces are then combined to create the customized and preferred three-dimensional nail object.

20. The process of claim 11, wherein the desired nail object in its final state is a customized three-dimensional object representing an artificial nail that is desired, which fits over the digitized nail surface.

21. A computer program to automatically create a three-dimensional nail object, comprising:
starting with a three-dimensional array of data representing a digitized nail surface, and;
measuring key reference points along the nail surface along the X-axis, Y-axis, Z-axis and the periphery of the digitized nail surface, and;
morphing the digitized nail surface into a preexisting preferred artificial nail surface to create a customized top nail surface, and;
combining the morphing top nail surface with the digitized nail surface to create a final customized and preferred three-dimensional artificial nail object that conforms to an expected result so that the nail object will fit over the digitized nail surface and create a desired artificial nail appearance.

22. The computer program of claim 21, wherein starting with a three-dimensional array of data representing a digitized nail surface includes any data that can be used to represent a three-dimensional object.

23. The computer program of claim 21, wherein the three-dimensional array of data may be represented as points of data representing an X-axis, Y-axis and Z-axis. The three-dimensional array of data may also include the points defining the periphery of the digitized nail surface.

24. The computer program of claim 21, wherein measuring key reference points includes determining the measurement value in millimeters or inches of the nail surface along its X-axis, Y-axis and Z-axis; where X-axis represents width, Y-axis represents the length and Z-axis represents depth.

25. The computer program of claim 21, wherein measuring key reference points includes determining the arc of the digitized nail surface along the X-axis and/or determining the arc of the nail surface along the Y-axis.

26. The computer program of claim 21, wherein measuring key reference points includes evaluating three-dimensional points along the periphery of the nail surface.

27. The computer program of claim 21, wherein morphing the digitized surface includes an iteration of mathematically manipulating the three-dimensional point array of the digitized nail surface to become more similar along the X-axis, Y-axis and Z-axis to the three-dimensional point array of the preexisting and preferred three-dimensional nail surface point array.

28. The computer program of claim 27, wherein the process of mathematically becoming more similar would be considered an iteration and the morphing process may take several iterations to arrive at a desired top surface object.

29. The computer program of claim 21, wherein the customized and preferred nail object is achieved by combining the three-dimensional point array from the morphing process as the top surface of the desired nail object and the digitized nail surface forms the bottom surface of the desired nail object. The two surfaces are then combined to create the customized and preferred three-dimensional nail object.

30. The computer program of claim 21, wherein the desired nail object in its final state is a customized three-dimensional object representing an artificial nail that is desired, which fits over the digitized nail surface.
